(19) United States
(12) Patent Application Publication
(10) Pub. No.: US 2020/0182326 A1
(43) Pub. Date: Jun. 11, 2020

(54) HYDRAULIC ENGINE MOUNT

(71) Applicants: Hyundai Motor Company, Seoul (KR); Kia Motors Corporation, Seoul (KR)

(72) Inventor: Jang Ho KIM, Yongin-Si (KR)

(73) Assignees: Hyundai Motor Company, Seoul (KR); Kia Motors Corporation, Seoul (KR)

(21) Appl. No.: 16/448,431

(22) Filed: Jun. 21, 2019

(30) Foreign Application Priority Data
Dec. 7, 2018 (KR) 10-2018-0156810

(51) Int. Cl. F16F 13/10; B60K 5/12

(52) U.S. Cl. CPC F16F 13/106; B60Y 2306/09; B60K 5/1208

(57) ABSTRACT

A hydraulic engine mount may include a nozzle plate including upper and lower nozzle plates, wherein each of the upper and lower nozzle plates may include a rim having an annular shape and forming a peripheral portion of the nozzle plate, a hub disposed at a central portion of the nozzle plate, and ribs connecting the rim and the hub while close contacting and supporting the membrane, and wherein the contact area between each rib of the upper nozzle plate and the membrane differs from the contact area between each rib of the lower nozzle plate and the membrane.

### CROSS-REFERENCE TO RELATED APPLICATION

The present application claims priority to Korean Patent Application No. Korean Patent Application No. 10-2018-0156810 filed on Dec. 7, 2018, the entire contents of which is incorporated herein for all purposes by the present reference.

### BACKGROUND OF THE INVENTION

### Field of the Invention

The present invention relates to a hydraulic engine mount, and particularly, to an improved hydraulic engine mount configured for preventing generation of noise such as rattle noise and cavitation noise.

### Description of Related Art

To address continuing development of vehicle technologies and increasing consumer demand for low vibration and low noise, efforts have been made to maximize ride comfort through analysis of noise, vibration, and harshness generated in vehicles.

Engine vibration generated in a specific RPM range while driving of a vehicle is transferred to a passenger compartment via a vehicle body while having a specific frequency. Phenomena exhibited due to explosion occurring in an engine have predominant influence on the passenger compartment.

Vibration is always generated at the engine of a vehicle due to structural factors such as periodic central position displacement caused by vertical movement of a piston and a connecting rod and periodic variation in inertial force of reciprocating portions exerted in an axial direction of a cylinder, inertial force generated due to lateral wobble of the connecting rod with respect to a crank shaft, and rotational force applied to the crank shaft.

To the present end, an engine mount is mounted between the engine of the vehicle and a vehicle body to attenuate noise and vibration transferred from the engine. Engine mounts are broadly classified into rubber engine mounts, air damping engine mounts, and hydraulic engine mounts.

Rubber engine mounts, which typically use a rubber material, have drawbacks in that they are very vulnerable to low-frequency and large-displacement vibration and do not have a sufficiently satisfactory attenuation performance for both high-frequency and low-amplitude vibration and low-frequency and large-displacement vibration.

In the present regard, a hydraulic engine mount is widely employed in that it can absorb and attenuate vibration in a wide range including high-frequency and non-amplitude vibration, low-frequency and large-displacement vibration, and other vibration, which are input to the engine mount during operation of the engine.

Such a hydraulic engine mount is also referred to as a “fluid mount” or a “hydro-mount”. The hydraulic engine mount has a structure in which damping force is generated as a fluid sealed beneath an insulator flows through a fluid path between an upper fluid chamber and a lower fluid chamber. The hydraulic mount has an advantage in that it may be possible to attenuate both high-frequency vibration (small-displacement vibration) and low-frequency vibration (large-displacement vibration) in accordance with vehicle driving conditions. FIG. 1 is a sectional view showing a conventional hydraulic engine mount.

Referring to FIG. 1, a nozzle plate 150, which may include an upper nozzle plate 151 and a lower nozzle plate 152, is shown. A membrane 160 is disposed in a space between the upper nozzle plate 151 and the lower nozzle plate 152.

In the above-mentioned configuration of the nozzle plate 150, the upper and lower nozzle plates 151 and 152 define the space to receive the membrane 160. In the instant case, the upper and lower nozzle plates 151 and 152 function as a kind of housing receiving the membrane 160 and restraining movement of the membrane 160.

However, the conventional hydraulic engine mount has a problem in that noise is generated in the internal of the engine mount due to various factors.

In the conventional hydraulic engine mount, noise may be generated due to a pressure variation difference occurring in the engine mount when an increased damping force is obtained through an increase in pumping area in the mount to improve sense of aftershock exhibited as the vehicle drives over speed bumps or the like.

Furthermore, in the conventional hydraulic engine mount, there are problems such as rattle noise generated as the membrane 160 is excited and cavitation noise generated when cavities (air bubbles) disappear after being produced in accordance with fluid pressure variation.

That is, rattle noise may be generated as the membrane 160 is excited in accordance with pressurization of the fluid in the engine mount during excitation, mainly compression, of the engine mount.

Meanwhile, there may be a cavitation phenomenon in which air bubbles (cavities) are produced in the fluid and then burst in accordance with variation in fluid pressure in the engine mount (positive pressure ↔negative pressure). When such a cavitation phenomenon occurs, noise, namely, cavitation noise, may be generated.

The information included in this Background of the Invention section is only for enhancement of understanding of the general background of the invention and may not be taken as an acknowledgement or any form of suggestion that this information forms the related art already known to a person skilled in the art.

### BRIEF SUMMARY

Various aspects of the present invention are directed to providing an improved hydraulic engine mount configured for preventing generation of noise such as rattle noise and cavitation noise.

Various aspects of the present invention are directed to providing a hydraulic engine mount including an insulator defining a fluid chamber, a nozzle plate connected to the insulator and dividing the fluid chamber into an upper fluid chamber and a lower fluid chamber, the nozzle plate defining the upper fluid chamber with the insulator and having an orifice to guide flow of a fluid between the upper fluid chamber and the lower fluid chamber, a membrane located between upper and lower nozzle plates of the nozzle plate, and a diaphragm connected to the nozzle plate and defining the lower fluid chamber with the nozzle plate, wherein each of the upper and lower nozzle plates may include a rim having an annular shape and forming a peripheral portion of the nozzle plate, a hub disposed at a central portion of the nozzle plate, and ribs connecting the rim and the hub while closely contacting and supporting the membrane, and wherein a contact area between each rib of the upper nozzle plate and the membrane differs from a contact area between each rib of the lower nozzle plate and the membrane.

In an exemplary embodiment of the present invention, each of the ribs may have a quadrangular cross-sectional shape, and a rib width corresponding to a lower side length of each rib of the upper nozzle plate contacting the membrane in a cross-section of the rib of the upper nozzle plate may differ from a rib width corresponding to an upper side length of each rib of the lower nozzle plate contacting the membrane in a cross-section of the rib of the lower nozzle plate.

In another exemplary embodiment of the present invention, the rib width of the upper nozzle plate may be smaller than the rib width of the lower nozzle plate.

In yet another exemplary embodiment of the present invention, the contact area between each rib of the upper nozzle plate and the membrane may be smaller than the contact area between each rib of the lower nozzle plate and the membrane.

In yet another exemplary embodiment of the present invention, an area of an upper surface portion of the membrane exposed to the upper fluid chamber without being shielded by the ribs of the upper nozzle plate may be greater than an area of a lower surface portion of the membrane exposed to the lower fluid chamber without being shielded by the ribs of the lower nozzle plate.

In still yet another exemplary embodiment of the present invention, the ribs in each of the upper and lower nozzle plates may extend radially between the corresponding rim and the corresponding hub such that the ribs may be radially disposed around the corresponding hub, and each rib of the upper nozzle plate and each rib of the lower nozzle plate may closely contact and support upper and lower surfaces of the membrane at the same position, respectively.

In still yet another exemplary embodiment of the present invention, the membrane may be a film type membrane made of a single deformable material.

In still yet another exemplary embodiment of the present invention, the membrane may be a film type membrane made of a rubber material alone.

Other aspects and exemplary embodiments of the present invention are discussed infra.

Thus, in the hydraulic engine mount according to an exemplary embodiment of the present invention, the deformation degree is varied in accordance with the direction of load applied to the engine mount in an assembled state of the upper nozzle plate, lower nozzle plate and membrane because the rib widths of the upper and lower nozzle plates are set to differ from each other.

Accordingly, it may be possible to control the volume variation of the upper fluid chamber in accordance with the direction of load applied to the engine mount. It may also be possible to eliminate noise problems by utilizing the existing nozzle plate and membrane as much as possible without addition of separate structures or parts, as compared to conventional engine mounts eliminating noise problems through application of membrane cut-outs unfavorable in terms of durability or a 1-way valve.

Furthermore, it may be possible to vary the volume of the upper fluid chamber through flow of an internal fluid and variation in fluid pressure according to the fluid flow, without addition of separate structures or portions and, as such, there is an advantage in that contradictory performances, that is, suppression of noise generation and improvement of aftershock sense (ride comfort), may be completely satisfied.

That is, the deformation degree of the membrane is small during application of positive pressure (application of load to the engine mount in a compression direction), resulting in an increase in damping value, whereas the deformation degree of the membrane is large during application of negative pressure (application of load to the engine mount in a tension direction), resulting in a decrease in pressure difference. Accordingly, the possibility that air bubbles as a cause of cavitation are produced may be reduced. As a result, cavitation noise may be reduced.

It is understood that the term “vehicle” or “vehicular” or other similar term as used herein is inclusive of motor vehicles in general such as passenger vehicles including sports utility vehicles (SUV), buses, trucks, various commercial vehicles, watercraft including a variety of boats and ships, aircraft, and the like, and may include hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

The above and other features of the present invention are discussed infra.

### BRIEF DESCRIPTION OF THE DRAWINGS

FIG. 1 is a sectional view showing a conventional hydraulic engine mount;

FIG. 2 is a sectional view exemplarily illustrating a hydraulic engine mount according to an exemplary embodiment of the present invention;

FIG. 3 is a perspective view exemplarily illustrating a separated state of a nozzle plate and a membrane in the engine mount according to the exemplary embodiment of the present invention;

FIG. 4 is a view showing comparison of rib widths of upper and lower nozzle plates in the engine mount according to the exemplary embodiment of the present invention;

FIG. 5 is a perspective view exemplarily illustrating a coupled state of the upper and lower nozzle plates in the engine mount according to the exemplary embodiment of the present invention; and

FIG. 6 and FIG. 7 are views illustrating deformed states of the membrane in the engine mount according to the exemplary embodiment of the present invention.

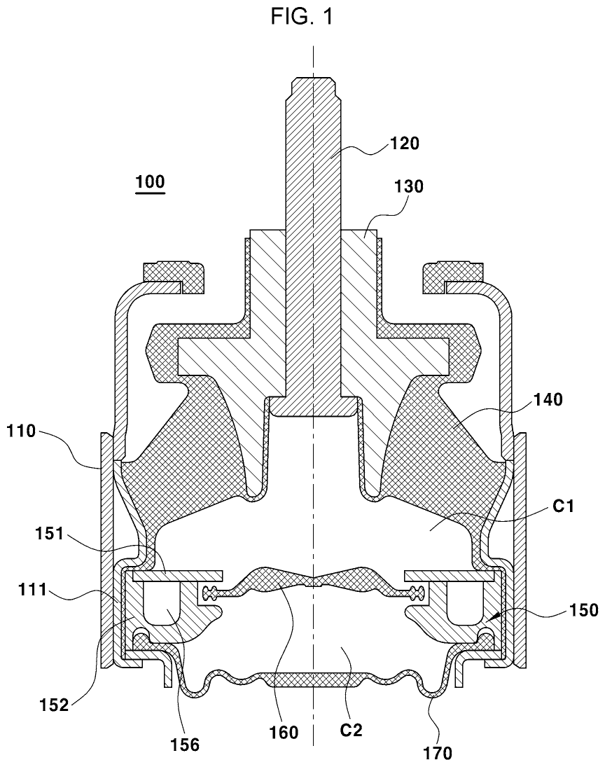

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

The terms “including” and variations thereof disclosed herein mean “including but not limited to” unless expressly specified otherwise, and, as such, should not be construed to exclude elements other than the elements disclosed herein and should be construed to further include additional elements.

The present invention relates to an improved hydraulic engine mount configured for preventing generation of noise such as rattle noise and cavitation noise.

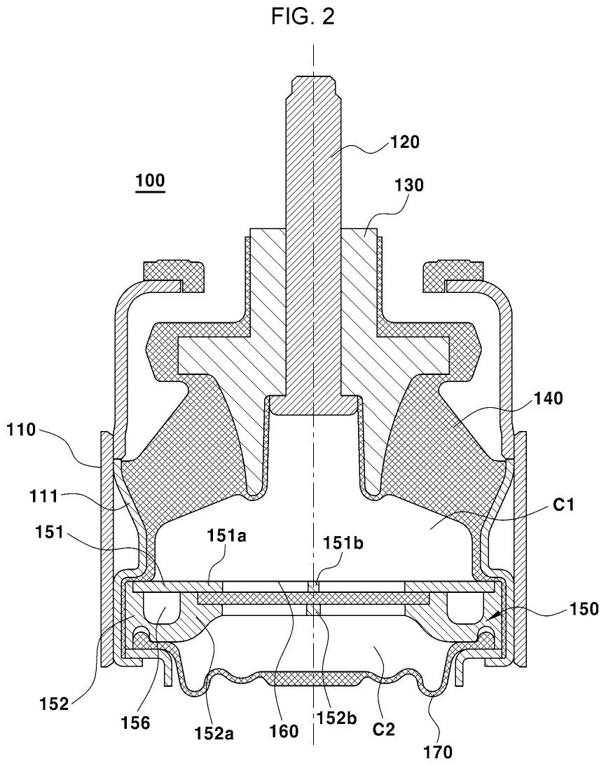

FIG. 2 is a sectional view exemplarily illustrating a hydraulic engine mount according to an exemplary embodiment of the present invention.

The hydraulic engine mount is also referred to as a “hydro engine mount”. Such a hydraulic engine mount is disposed between an engine and a vehicle body, for vibration insulation. The hydraulic engine mount is filled with a fluid and sealed.

As illustrated in FIG. 2, the hydraulic engine mount, which is designated by reference numeral “100”, includes a housing 110 fastened to the side of a vehicle body via a mounting bracket not shown, a center bolt 120 fastened to the side of an engine, an internal core 130, to which the center bolt 120 is coupled, and an insulator 140 including a rubber material and molded to be integrally coupled to the internal core 130.

The insulator 140 is also referred to as a “main rubber” or a “mount rubber”. The insulator 140 is internally disposed within the housing 110, to hold and support the internal core 130. The insulator 140 defines an upper fluid chamber C1 with a nozzle plate 150 disposed under the insulator 140.

The insulator 140 is securely fitted, at a lower portion thereof, in an external pipe 111 within the housing 110. In the instant case, the external pipe 111 is fitted in the housing 110 such that the external pipe 111 is coupled to the housing 110 while enclosing the lower portion of the insulator 140.

The external pipe 111 not only is configured to protect the nozzle plate 150 and a diaphragm 170, which are internally disposed within the external pipe 111, but also is configured to maintain coupled states of the insulator 140, nozzle plate 150 and diaphragm 170 while supporting the insulator 140 and nozzle plate 150.

The nozzle plate 150 is transversely internally disposed within the external pipe 111, to divide a fluid chamber defined in the engine mount 100 into an upper fluid chamber C1 and a lower fluid chamber C2. The nozzle plate 150 has an orifice 156 to form a bypass channel for guiding a flow of fluid between the upper fluid chamber C1 and the lower fluid chamber C2.

In the instant case, the nozzle plate 150 is formed with a hole for connecting the orifice 156 to the upper fluid chamber C1, and a hole for connecting the orifice 156 to the lower fluid chamber C2.

Accordingly, the upper fluid chamber C1 communicates with the orifice 156 via the associated hole to enable fluid flow therebetween, and the lower fluid chamber C2 communicates with the orifice 156 via the associated hole to enable fluid flow therebetween,

That is, the orifice 156 provides an annular channel, through which a fluid can flow, and communicates with both the upper fluid chamber C1 and the lower fluid chamber C2 via the holes.

Thus, the orifice 156 provides a kind of fluid passage connecting the upper and lower fluid chambers C1 and C2, namely, a flow channel allowing a fluid to flow between the chambers C1 and C2.

Furthermore, the diaphragm 170 is disposed under the nozzle plate 150 within the external pipe 111, to define the lower fluid chamber C2. In detail, the diaphragm 170 defines the lower fluid chamber C2 with the nozzle plate 150.

Under the condition that the fluid chamber defined in the housing 110 is filled with a fluid and sealed, the engine mount 100 having the above-described configuration has a structure in which the upper fluid chamber C1 is defined between the nozzle plate 150 and the insulator 140, and the lower fluid chamber C2 is defined between the nozzle plate 150 and the diaphragm 170.

That is, the engine mount 100 has a structure in which the upper and lower fluid chambers C1 and C2 are formed at opposite sides of the nozzle plate 150 within the engine mount 100 such that the upper fluid chamber C1 is disposed over the nozzle plate 150 and the lower fluid chamber C2 is disposed under the nozzle plate 150.

The diaphragm 170 may deform in accordance with state of vibration input to the mount 100, state of a fluid flow between the upper and lower fluid chambers C1 and C2 depending on the input vibration, and state of fluid pressure in the lower fluid chamber C2 depending on the input vibration. When the diaphragm 170 deforms, the volume of the lower fluid chamber C2 filled with the liquid is correspondingly varied.

Meanwhile, the nozzle plate 150 includes an upper nozzle plate 151 and a lower nozzle plate 152, as described above. A membrane 160 is disposed in a space defined between the upper nozzle plate 151 and the lower nozzle plate 152.

Thus, the upper fluid chamber C1 is a fluid-filled space defined among the insulator 140, the upper nozzle plate 151 and the membrane 160, whereas the lower fluid chamber C2 is a fluid-filled space defined among the lower nozzle plate 152, the membrane 160 and the diaphragm 170.

Furthermore, the lower nozzle plate 152 is provided, at a peripheral portion thereof, with the orifice 156 formed to be annularly disposed along peripheral portions of the upper and lower fluid chambers C1 and C2. The upper nozzle plate 151 is disposed over the orifice 156 and covers the orifice 156.

The orifice 156 is also referred to as an “inertia track”. The nozzle plate 150 is also referred to as an “orifice plate”, the upper nozzle plate 151 is also referred to as an “upper orifice plate”, and the lower nozzle plate 152 is also referred to as a “lower orifice plate”.

In the above-described configuration of the nozzle plate 150, the upper and lower nozzle plates 151 and 152 define a space to receive the membrane 160. In the instant case, the upper and lower nozzle plates 151 and 152 function as a kind of housing for receiving the membrane 160 and restraining movement of the membrane 160.

Furthermore, the upper nozzle plate 151, which defines the membrane receiving space, is formed with a through hole for connecting the membrane receiving space and the upper fluid chamber C1 (a space between neighboring ribs to be described hereinafter). The lower nozzle plate 152, which defines the membrane receiving space, is formed with a through hole for connecting the membrane receiving space and the lower fluid chamber C2 (a space between neighboring ribs to be described hereinafter).

Accordingly, when vibration is transferred from the side of the engine to the internal core 130 and the insulator 140 via the center bolt 120 in the hydraulic engine mount 100 configured as described above, the insulator 140 deforms, causing the upper fluid chamber C1 to be varied in volume. As a result, an amount of fluid corresponding to the varied volume flows from the upper fluid chamber C1 to the lower fluid chamber C2.

The fluid flowing in the above-described manner attenuates impact harshness while flowing along the annular orifice 156 after entering the orifice 156 through the hole of the upper nozzle plate 151 or passing through a gap between the upper nozzle plate 151 and the membrane 160 and a gap between the membrane 160 and the lower nozzle plate 152.

For example, during idling of the engine, the fluid flows through fine gaps between the membrane 160 and the upper and lower orifice plates 151 and 152 because the engine vibrates slightly and, as such, a decrease in spring value (decrease in stiffness coefficient K) occurs.

On the other hand, while driving of the vehicle on a rough road, the gaps between the membrane 160 and the upper and lower orifice plates 151 and 152 are closed because the engine exhibits large-displacement vibration. Instead, the fluid flows along the annular channel of the orifice 156 and, as such, an increase in attenuation force (increase in damping coefficient C) occurs.

Hereinafter, the nozzle plate and membrane in the engine mount according to the exemplary embodiment of the present invention will be described in more detail.

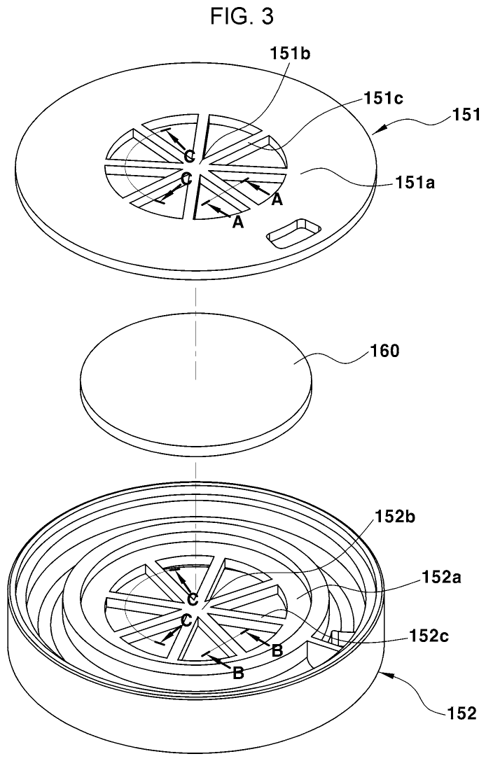

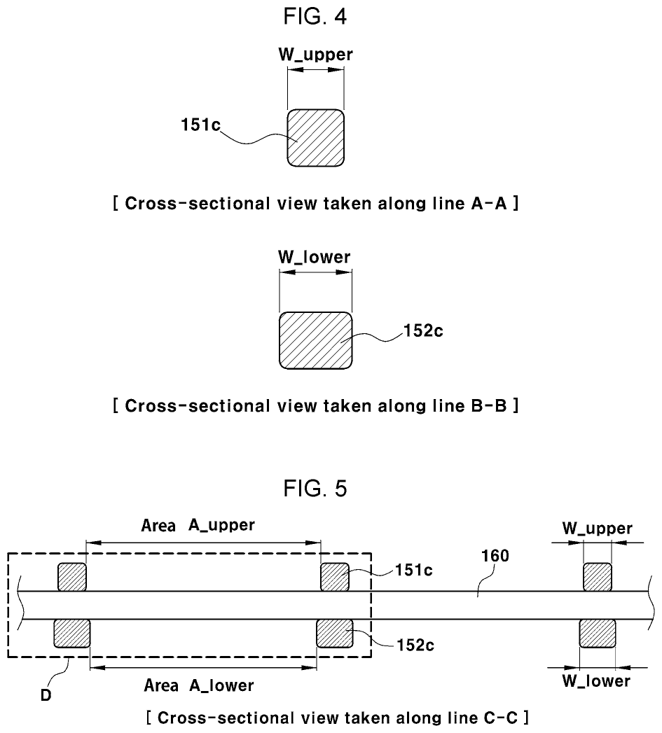

FIG. 3 is a perspective view exemplarily illustrating a separated state of the nozzle plate and membrane in the engine mount according to the exemplary embodiment of the present invention. FIG. 4 is a view showing comparison of rib widths of the upper and lower nozzle plates in the engine mount according to the exemplary embodiment of the present invention.

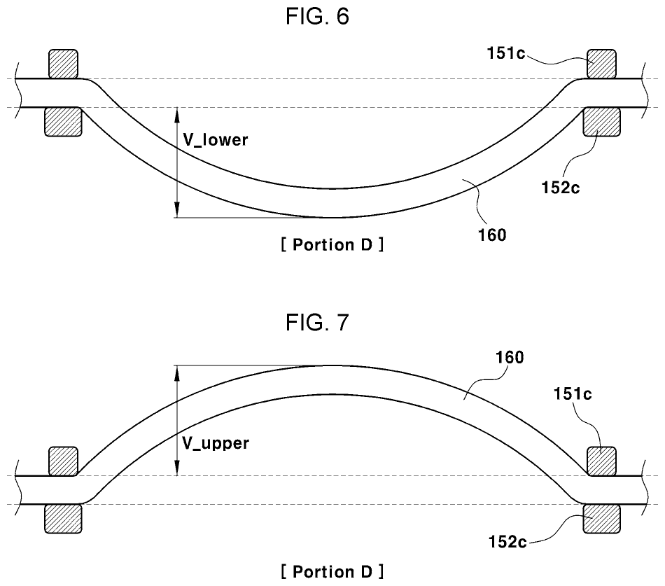

FIG. 5 is a perspective view exemplarily illustrating a coupled state of the upper and lower nozzle plates in the engine mount according to the exemplary embodiment of the present invention. FIG. 6 and FIG. 7 are views illustrating deformed states of the membrane in the engine mount according to the exemplary embodiment of the present invention.

As illustrated in FIG. 3, each of the upper and lower nozzle plates 151 and 152 includes a rim 151a or 152a having a circular annular shape and forming a peripheral portion of the nozzle plate 151 or 152, a hub 151b or 152b disposed at a central portion of the nozzle plate 151 or 152, and ribs 151c or 152c extending radially between the rim 151a or 152a and the hub 151b or 152b and connecting the rim 151a or 152a and the hub 151b or 152b.

The ribs 151c or 152c extend radially from the hub 151b or 152b such that the ribs 151c or 152c are radially disposed around the hub 151b or 152b. As may be seen from FIG. 4, each rib 151c or 152c has a substantially quadrangular cross-sectional shape.

FIG. 4 is a cross-sectional view showing each rib 151c of the upper nozzle plate 151 and each rib 152c of the lower nozzle plate 152, to illustrate cross-sectional shapes of the ribs 151c and 152c. FIG. 4 depicts cross-sectional shapes taken along lines A-A and B-B of FIG. 3.

The left cross-sectional view in FIG. 4 shows the cross-sectional shape of each rib of the upper nozzle plate 151, whereas the right cross-sectional view in FIG. 4 shows the cross-sectional shape of each rib of the lower nozzle plate 152.

As illustrated in FIG. 4, in the upper and lower nozzle plates 151 and 152, cross-sectional widths of the ribs 151c and 152c, that is, horizontal lengths or widths of upper horizontal sides corresponding to upper rib faces of the ribs 151c and 152c and horizontal lengths or widths of lower horizontal sides corresponding to lower rib surfaces of the ribs 151c and 152c (hereinafter, referred to as “rib widths”), are different from each other.

In the instant case, the rib width W_upper of the upper nozzle plate 151 is smaller than the rib width W_lower of the lower nozzle plate 152.

That is, when the ribs 151c of the upper nozzle plate 151 and the ribs 151c of the lower nozzle plate 152 have substantially quadrangular cross-sectional shapes, the rib width W_upper, which is each longitudinal length of the upper and lower horizontal rib sides in the upper nozzle plate 151, is different from the rib width W_lower, which is each longitudinal length of the upper and lower horizontal rib sides in the lower nozzle plate 152. The rib width W_upper of the upper nozzle plate 151 is smaller than the rib width W_lower of the lower nozzle plate 152.

Assuming that “W_upper” represents the rib width of the upper nozzle plate 151, and “W_lower” represents the rib width of the lower nozzle plate 152, the relationship between the rib widths of the upper and lower nozzle plates 151 and 152 may be expressed by “W_upper<W_lower”.

The condition that the rib width W_upper of the upper nozzle plate 151 is smaller than the rib width W_lower of the lower nozzle plate 152 means that the horizontal length of the lower horizontal side of each rib 151c in the upper nozzle plate 151 is smaller than the horizontal length of the upper horizontal side of each rib 152c in the lower nozzle plate 152.

Furthermore, the present means that the contact area between each rib 151c of the upper nozzle plate 151 and an upper surface of the membrane 160 is smaller than the contact area between each rib 152c of the lower nozzle plate 152 and a lower surface of the membrane 160.

That is, in accordance with the contact area relationship between the ribs 151c and 152c with respect to the membrane 160 in the exemplary embodiment of the present invention, each rib 152c of the lower nozzle plate 152 is in contact with the membrane 169 in a larger area than each rib 151c of the upper nozzle plate 151.

Furthermore, the condition that the contact area between each rib 151c of the upper nozzle plate 151 and the membrane 160 is smaller than the contact area between each rib 152c of the lower nozzle plate 152 and the membrane 160 means that the contact area between the upper nozzle plate 151 and the membrane 160 is smaller than the contact area between the lower nozzle plate 152 and the membrane 160, and the membrane 160 is exposed at the upper nozzle plate 151 in a larger area than at the lower nozzle plate 152.

That is, the area of an upper surface portion of the membrane 160 exposed to the upper fluid chamber (designated by “C1” in FIG. 2) without being shielded by the ribs 151c of the upper nozzle plate 151 (the exposed area of the upper surface of the membrane) is greater than the area of a lower surface portion of the membrane 160 exposed to the lower fluid chamber (designated by “C2” in FIG. 2) without being shielded by the ribs 152c of the lower nozzle plate 152 (the exposed area of the lower surface of the membrane).

Thus, in an assembled state of the upper nozzle plate 151, lower nozzle plate 152, and the membrane 160 according to the exemplary embodiment of the present invention, the area of the membrane 160 exposed to the upper fluid chamber (the exposed area of the upper surface of the membrane) differs from the area of the membrane 160 exposed to the lower fluid chamber (the exposed area of the lower surface of the membrane). The area of the membrane 160 exposed to the upper fluid chamber is greater than the area of the membrane 160 exposed to the lower fluid chamber.

FIG. 5 is a cross-sectional view taken along line C-C in FIG. 3. FIG. 5 illustrates a state in which the membrane 160 is located between the upper nozzle plate 151 and the lower nozzle plate 152, to be coupled thereto.

As illustrated in FIG. 5, the upper and lower nozzle plates 151 and 152 may have the same number of ribs 151c and 152c, respectively.

In the instant case, the ribs 151c of the upper nozzle plate 151 and the ribs 152c of the lower nozzle plate 152 are disposed over and under the membrane 160, respectively, to support the upper and lower surfaces of the membrane 160 interposed therebetween while being in close contact with the upper and lower surfaces of the membrane 160. The positions of the corresponding ribs 151c and 152c of the upper and lower nozzle plates 151 and 152 on the membrane 160 are determined to coincide with each other.

That is, although the rib widths W_upper and W_lower of the upper and lower nozzle plates 151 and 152 differ from each other, the corresponding ribs 151c and 152c are disposed at the same position on the membrane 160 and, as such, closely contact and support upper and lower surfaces of the corresponding portion of the membrane 160 from above and below, respectively.

Furthermore, referring to FIG. 5, it may be seen that the exposed surface of the upper surface of the membrane 160 not shielded by the ribs 151c is greater than the exposed surface of the lower surface of the membrane 160 not shielded by the ribs 152c because the rib width W_upper of the upper nozzle plate 151 is smaller than the rib width W_lower of the lower nozzle plate 152.

That is, the area of the membrane exposed to the upper fluid chamber is greater than the area of the membrane exposed to the lower fluid chamber.

Assuming that “A_upper” represents the area of the membrane exposed to the upper fluid chamber, and “A_lower” represents the area of the membrane exposed to the lower fluid chamber, the relationship between the exposed areas may be expressed by “A_upper<A_lower”.

In the above-described mount configuration in which the rib widths W_upper and W_lower of the upper and lower nozzle plates 151 and 152 differ from each other, the deformation degree of the membrane 160 is small during application of positive pressure, resulting in an increase in damping value, while being large during application of negative pressure, resulting in a decrease in pressure difference.

When a decrease in pressure difference occurs due to an increased deformation degree of the membrane 160, the possibility that air bubbles as a cause of cavitation are produced may be reduced. As a result, cavitation noise may be reduced.

FIG. 6 and FIG. 7 are views illustrating deformed states of the membrane 160 in the engine mount according to the exemplary embodiment of the present invention.

In the engine mount according to the exemplary embodiment of the present invention, a film type membrane 160 made of a single deformable material, which differs from a structure having an embedded metal core, may be used as the membrane 160. In the instant case, a film type membrane made of a rubber material alone may be used as the membrane 160.

As such, the membrane 160 may exhibit the deformed states of FIG. 6 and FIG. 7.

FIG. 6 shows the state in which the insulator 140 is deformed downwards as load is applied in a compression direction to the engine mount and, as such, the pressure of the upper fluid chamber (main fluid chamber) (“C1” in FIG. 2) becomes higher than the pressure of the lower fluid chamber (auxiliary fluid chamber) (“C2” in FIG. 2).

When the pressure of the upper fluid chamber is higher than the pressure of the lower fluid chamber, the portion of the membrane 160 located between neighboring ones of the ribs 151c and 152c of the upper and lower nozzle plates 151 and 152 is deformed to move downwards.

Meanwhile, FIG. 7 shows the state in which the insulator 140 is deformed upwards as load is applied in a tension direction to the engine mount and, as such, the pressure of the upper fluid chamber (main fluid chamber) becomes lower than the pressure of the lower fluid chamber (auxiliary fluid chamber).

When the pressure of the upper fluid chamber is lower than the pressure of the lower fluid chamber, the portion of the membrane 160 located between neighboring ones of the ribs 151c and 152c of the upper and lower nozzle plates 151 and 152 is deformed to move upwards.

States of the membrane 160 indicated by dotted lines in FIG. 6 and FIG. 7 represent a state in which the membrane 160 is horizontally maintained. When there is no difference between the pressure of the upper fluid chamber and the pressure of the lower fluid chamber, the membrane 160 is maintained in a horizontal state as indicated by the dotted lines.

When the membrane 160 exhibits a deformed state in which the membrane 160 moves downwards, during compression, as illustrated in FIG. 6, the deformation degree of the membrane 160 in compression may be defined by the vertical distance V_lower of the maximally descending portion D of the membrane 160 from the horizontal state of the membrane 160.

Furthermore, when the membrane 160 exhibits a deformed state in which the membrane 160 moves upwards, during tension, as illustrated in FIG. 7, the deformation degree of the membrane 160 in tension may be defined by the vertical distance V_upper of the maximally ascending portion D of the membrane 160 from the horizontal state of the membrane 160.

In the instant case, the deformation degree V_lower of the membrane 160 in compression as illustrated in FIG. 6 is greater than the deformation degree V_upper of the membrane 160 in tension as illustrated in FIG. 7 because the area A_lower of the membrane 160 exposed to the lower fluid chamber is smaller than the area A_upper of the membrane 160 exposed to the upper fluid chamber.

This may be expressed by “V_lower<V_upper”. In the engine mount according to the exemplary embodiment of the present invention, the condition “V_lower<V_upper” is exhibited during deformation of the membrane 160.

Thus, in the hydraulic engine mount according to an exemplary embodiment of the present invention, the deformation degree is varied in accordance with the direction of load applied to the engine mount in an assembled state of the upper nozzle plate, lower nozzle plate and membrane because the rib widths of the upper and lower nozzle plates are set to differ from each other.

Accordingly, it may be possible to control the volume variation of the upper fluid chamber in accordance with the direction of load applied to the engine mount. It may also be possible to eliminate noise problems by utilizing the conventional nozzle plate and membrane as much as possible without addition of separate structures or parts, as compared to conventional engine mounts eliminating noise problems through application of membrane cut-outs unfavorable in terms of durability or a 1-way valve.

Furthermore, it may be possible to vary the volume of the upper fluid chamber through flow of an internal fluid and variation in fluid pressure according to the fluid flow, without addition of separate structures or portions and then, there is an advantage in that contradictory performances, that is, suppression of noise generation and improvement of aftershock sense (ride comfort), may be completely satisfied.

That is, the deformation degree of the membrane is small during application of positive pressure (application of load to the engine mount in a compression direction), resulting in an increase in damping value, whereas the deformation degree of the membrane is large during application of negative pressure (application of load to the engine mount in a tension direction), resulting in a decrease in pressure difference. Accordingly, the possibility that air bubbles as a cause of cavitation are produced may be reduced. As a result, cavitation noise may be reduced.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A hydraulic engine mount comprising:
an insulator defining a fluid chamber;
a nozzle plate connected to the insulator and dividing the fluid chamber into an upper fluid chamber and a lower fluid chamber, the nozzle plate defining the upper fluid chamber with the insulator and having an orifice to guide flow of a fluid between the upper fluid chamber and the lower fluid chamber;
a membrane located between upper and lower nozzle plates of the nozzle plate and defining the upper fluid chamber with the nozzle plate; and
a diaphragm connected to the nozzle plate and defining the lower fluid chamber with the nozzle plate,
wherein each of the upper and lower nozzle plates includes a rim having an annular shape and forming a peripheral portion of the nozzle plate, a hub disposed at a central portion of the nozzle plate, and ribs connecting the rim and the hub while contacting and supporting the membrane, and
wherein a contact area between each rib of the upper nozzle plate and the membrane differs from a contact area between each rib of the lower nozzle plate and the membrane.

2. The hydraulic engine mount according to claim 1,
wherein each of the ribs has a quadrangular cross-sectional shape; and
wherein a rib width corresponding to a lower side length of each rib of the upper nozzle plate contacting the membrane in a cross-section of the rib of the upper nozzle plate differs from a rib width corresponding to an upper side length of each rib of the lower nozzle plate contacting the membrane in a cross-section of the rib of the lower nozzle plate.

3. The hydraulic engine mount according to claim 2,
wherein the rib width of the upper nozzle plate is smaller than the rib width of the lower nozzle plate.

4. The hydraulic engine mount according to claim 1,
wherein the contact area between each rib of the upper nozzle plate and the membrane is smaller than the contact area between each rib of the lower nozzle plate and the membrane.

5. The hydraulic engine mount according to claim 1,
wherein an area of an upper surface portion of the membrane exposed to the upper fluid chamber without being shielded by the ribs of the upper nozzle plate is greater than an area of a lower surface portion of the membrane exposed to the lower fluid chamber without being shielded by the ribs of the lower nozzle plate.

6. The hydraulic engine mount according to claim 1,
wherein the ribs in each of the upper and lower nozzle plates extend radially between the corresponding rim and the corresponding hub such that the ribs are radially disposed around the corresponding hub; and
wherein each rib of the upper nozzle plate and each rib of the lower nozzle plate contact and support upper and lower surfaces of the membrane at a same position, respectively.

7. The hydraulic engine mount according to claim 1,
wherein the membrane is a film type membrane made of a single deformable material.

8. The hydraulic engine mount according to claim 1,
wherein the membrane is a film type membrane made of a rubber material alone.
